(19) United States
(12) Patent Application Publication
(10) Pub. No.: US 2011/0231500 A1
(43) Pub. Date: Sep. 22, 2011

(54) System and method for integrating support case or ticket management systems via email

(75) Inventors: Ray Guosheng Zhu, Fremont, CA (US); Xingwu Chai, Vancouver, WA (US)

(73) Assignees: Mr. Ray Guosheng Zhu, Fremont, CA (US); Mr. Xingwu Chai, Vancouver, WA (US)

(21) Appl. No.: 13/048,868

(22) Filed: Mar. 16, 2011

Related U.S. Application Data
(60) Provisional application No. 61/315,932, filed on Mar. 20, 2010.

(51) Int. Cl. G06F 15/16

(52) U.S. Cl. 709/206

(57) ABSTRACT

A system and method for integrating a plurality of support case or ticket management systems via email is invented. Said system and method enable escalation of cases or tickets between existing support systems with no or limited customization. Said existing support system is any CRM, helpdesk or service desk system, and can be distributed across a plurality of organizations. The subject, body and other fields of a case can be represented by the subject, body and other fields of an email. And, because email is a built-in capability of many support systems, integration may be achieved without an adapter.

### 1. CROSS REFERENCE TO RELATED APPLICATIONS

This application claims the benefit of provisional patent application No. 61/315,932, filed 2010, Mar. 20 by the present inventor.

### 2. TECHNICAL FIELD

The present invention relates generally to B2B integration, electronic messaging, customer relationship management (CRM), Help Desk, Service Desk, trouble ticket management, support case management, customer support and services.

### 3. DESCRIPTION OF PRIOR ART

Internet connectivity has improved businesses efficiency and productivity dramatically, as many manual processes have been replaced by automation via electronic communications. For example, when an employee Mary Davis at Bank of America (BofA) has a broken LCD screen with her laptop, she could email or use a web browser to create an IT helpdesk ticket, and IT can respond to Mary with updates of the ticket via email or employee portal.

However, sometimes an IT helpdesk ticket needs to be escalated to the vendor for resolution or closure. In the previous example of a broken LCD screen, if IT staff Kevin Smith at BofA determines that the problem has to be addressed by the vendor Dell, he calls Dell tech support, and Dell would create a separate ticket in its CRM system. Technically, the second (Dell) ticket is an escalation of the first (IT helpdesk) ticket, but in reality, the two tickets are not automatically related or connected, the call to Dell is often recorded by Kevin Smith on a “Post-It” note. Needless to say, IT staff spends a major portion of its time processing vendor escalations manually.

The integration between support systems can be addressed by so-called adapters, which are tailor-made for each type of system, configured at each installation instance to facilitate the communication. The problem with adapters is that they can be difficult to develop, and hard to deploy and maintain. For example, a company BofA deals with hundreds of vendors, and each has its own CRM or ticketing system, it is unimaginable installing hundreds of adapters in BofA helpdesk system to allow escalations to as many vendors.

For organizations, the ability to provide superior customer support and service has become a critical success factor and key differentiator. The lack of integration of support systems is costing organizations in at least two ways: The operational resources needed in manual support escalation; and the loss of customer satisfaction due to delay and inaccuracy in such a manual process.

In view of the forgoing, there is a need for an improved method for integrating support systems which overcomes the limitations of the prior art, specifically, system and method for escalation of support cases and trouble tickets across multiple organizations requiring no or limited customization to existing systems.

### 4. SUMMARY

A system and method for integrating a plurality of support case or ticket management systems via email is invented. Said system and method enable escalation of cases or tickets between existing support systems with no or limited customization. Said existing support system is any CRM, helpdesk or service desk system, and can be distributed across a plurality of organizations. The subject, body and other fields of a case can be represented by the subject, body and other fields of an email. And, because email is a built-in capability of many support systems, integration may be achieved without an adapter.

### 5. LIST OF FIGURES

These and other features of this invention will be more readily understood from the following detailed description of the various aspects of the invention taken in conjunction with the accompanying drawing in which:

FIG. 1 depicts support systems messaging via email.

FIG. 2 depicts integrating support systems via email and a “support exchange”

### 6. DETAILED DESCRIPTION OF THE INVENTION

The present invention provides solution for integrating support systems via email. Additionally, multiple levels of escalations or chained escalations can be best achieved through a hub or Support Exchange that can adapt to different existing systems, requiring no or minimum changes to those existing systems.

For the simplicity of the discussion, and as an exemplary embodiment, the following elements and terminology are employed:
Case and ticket. For discussions in this application, a support ticket, service ticket, or ticket is used interchangeably with a support case, service case or case.
Support system, CRM, service desk, help desk and helpdesk. For discussions in this application, these terms are used interchangeably referring a system managing cases and tickets.
Vendors and customers are used to represent business partners or simply two parties involved in a business relationship in general.

The following facts should make this invention readily understood:
Current escalation between systems of different partners is practically manual and needs to be improved as discussed in the “Prior Art” section.
An email can be used to represent a support ticket because they are very similar in format. Key elements of an email as specified in RFC 2822 (Internet Message Format) include: From, To, Subject and Message Body, and similarly, a support ticket has similar elements: Customer, Vendor, Subject and Message Body. Both email and support ticket can have attachments, and both can be responded, commented or replied any number of times. If a customer in a support ticket can be identified by the “From” address of an email, and a vendor can be identified by the “To” address of an email, a ticket can be represented by an email message.
Most current CRM and helpdesk systems are capable of ticket creation and update via email, although one side is the system and the other is a human reading and processing the emails. To create a ticket, a customer typically sends an email to an address for support cases such as helpdesk@BofA.com, and the support system would monitor the email account and process inbound emails. Emails meeting the pre-configured rules would be converted to a ticket, and system sends an acknowledgment email to the customer with the Subject line prefixed with a ticket ID, such as, “Subject: [BofA#345] Laptop LCD broken”. From this point a customer can reply the acknowledgement email using the subject with a ticket ID, and all the replies will be associated with ticket BofA#345 in the system.
Email is handled by every organization, it requires no new skills, and no firewall changes to be used by support systems to pass ticket information.

With the above facts, the question becomes simple:

How can two support systems exchange ticket information using email format, instead of one system and one human?

The keys to integrating two support systems via email are as follows:
I. Source system and target system in each data transmission carried in the email can be correctly identified, either explicitly or implicitly. When a customer helpdesk system emails the vendor CRM system, the vendor CRM system needs to identify which organization and system the email came from, so it can correctly associate the ticket with a customer organization. Both source and target can be implied. For instance, if source system S is the only system that knows a particular email address and system T is the only system that processes the email address, the systems are implied.
II. Any response, comment or update to a ticket via email by either system can be associated with the correct ticket on both sides. At least one of the systems needs to recognize the ticket ID of the other system carried in the email messages. Every system assigns a unique ID to each ticket within, but the Ticket ID in one system may not be recognized by another, so it is necessary for a system receiving a message with a foreign Ticket ID to match with a local ticket ID. For a given customer issue, if the first of two systems knows the Ticket ID native to the second system, the first can always communicate with the second using the ID native to the second, in this case, it is not necessary for the second system to know the ticket ID native to the first, and vice versa.
III. Both sides understand each other how messages are constructed so that email fields can be correctly mapped to ticket fields by systems. Email message as currently specified in RFC 2822 (Internet Message Format) has many fields such as: From, To, Subject, Body, Attachment, Message-ID, References, Comments, Keywords, Reply-To, In-Reply-To, CC, BCC, Sender, which can be used to carry Ticket ID and other information pertaining to support tickets and systems. Any of the fields could be used to carry ticket ID, and information can be transferred plain-text, encoded or encrypted, as long as the receiving system knows how to translate and map it. For instance, some systems use “Reply-To” email field to identify its Ticket ID, when a customer or system replies, the reply-to address is effectively a pointer to the ticket ID.

Referring now to the drawings:

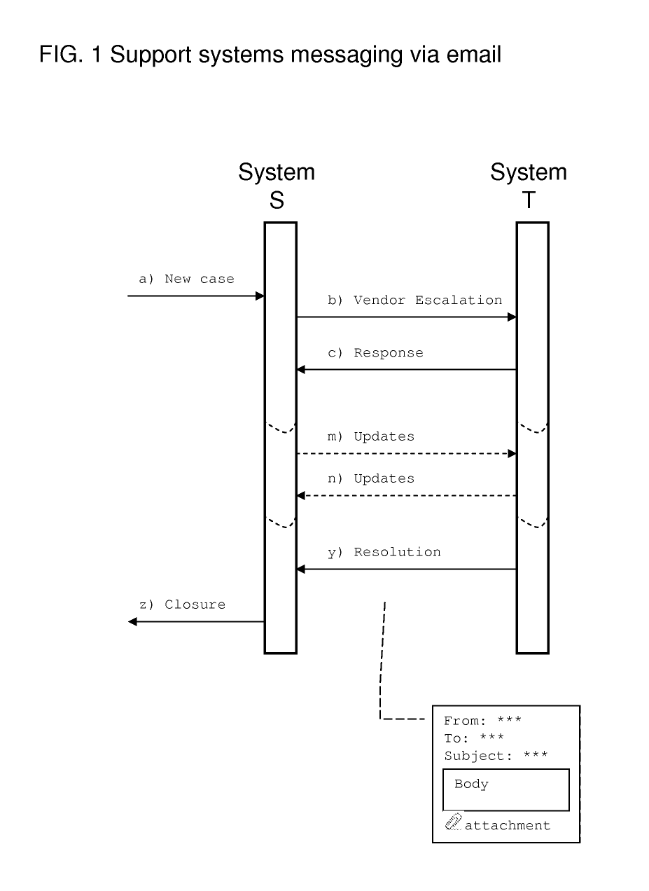

FIG. 1 depicts support systems messaging via email. A ticket opened in system S by a customer needed to be escalated to system T for resolution, and messages are exchanged via email.

This imaginary example is used for explanation: An employee Mary Davis at Bank of America (BofA) has a broken LCD screen with her laptop, she creates an IT helpdesk ticket (in System S). If IT staff Kevin Smith determines that the problem has to be addressed by the vendor Dell, he escalates the ticket out to Dell tech support, and Dell would create a separate ticket in its CRM system (System T).

Let's now look into detail how each of the email headers can be constructed in each step to transfer support ticket information among systems.
a) “New case”. A new case can be created in System S by a customer via email, phone, in person or other means. The case is recorded in a helpdesk or CRM system. This is a basic function of all support systems. In the example, an employee Mary Davis at BofA has a broken LCD screen with her laptop, she creates an IT helpdesk BofA#551 (System S).
b) “Vendor Escalation”. Escalation manager for System S initiates an email to System T. The email is generated out of System S based on the ticket information and it carries information referencing the current ticket. The mailbox of the “To” address should be monitored and processed by System T. In the example case, BofA IT staff Kevin Smith in charge of vendor escalation determines that Mary's problem must be addressed by the vendor Dell, he triggers an email out of the BofA helpdesk system with a header like this:
   From: helpdesk@BofA.com
   To: support@dell.com
   Subject: [BofA#551] Laptop LCD Broken
   Message: Dell, please advice. >>>Can't do anything without it
   assuming Dell CRM monitors and processes mailbox support@dell.com, and BofA helpdesk system monitors and processes helpdesk@BofA.com. Dell CRM system parses the above email, and identifies “From” address helpdesk@BofA.com is associated with customer BofA, and creates a ticket Dell-991 for BofA:
   Ticket ID: Dell-991
   Customer: Bank of America
   Subject: [BofA#551] Laptop LCD Broken
   Message: Dell, please advice. >>>Can't do anything without it
   It is conceivable Dell CRM is configured to recognize that the subject pattern [BofA#551] is the ticket ID used by BofA helpdesk system, and it saves this information in a “Customer Ticket ID” field in order to communicate back to BofA. An alternative is for Dell CRM to keep [BofA#551] in the subject line of the Dell CRM ticket, thus a reply to helpdesk@BofA.com with a subject containing [BofA#551] would be easily identified by BofA and associated with the correct ticket.
c) “Response”. System T sends a response back to System S via email. As long as ticket ID for System S is somewhere in the response and identifiable by System S, the response will be associated with the original ticket. In the example case, a response from Dell to BofA can look like.
   From: support@dell.com
   To: helpdesk@BofA.com
   Subject: RE: [BofA#551] Laptop LCD Broken
   Message: Received. We will update you. Michael Dell
   The response may optionally carry the ticket ID of System T, for instance, the subject line could be like. “RE: [BofA#551] Laptop LCD Broken/ref:Dell-991:ref/”, or the end of the message body could contain something like “/ref:Dell-991:ref/”, as long as the patterns used by both sides are distinct and non-conflicting, and each system is parsing its own pattern to find ticket ID.
m), n) “Updates”. Before a resolution is reached, additional updates can be sent by either side in no particular order. In the example case, updates can be sent by either Dell or BofA any number of times. Any update sent to Dell by BofA would carry BofA#551, and it will be associated with Dell-991 in Dell CRM; Any update sent to BofA by Dell on Dell-991 will be associated with BofA#551.
y) “Resolution”. Vendor (System T) offered a solution and sent update back to System S. In the example case, Mary's laptop has been replaced by Dell service personnel, and Dell closed ticket Dell-991. It's also possible resolution is found in System S first, and updates sent from System S to System T.
z) “Closure”. Ticket is closed and notification sent to customer. This is part of a regular step of all cases. In the example case, Mary's ticket BofA#551 is closed because her laptop has been replaced. It's also possible ticket is closed in System S first, and updates sent from System S to System T.

It is understood and appreciated that there are many ways to implement the integration of System S and T via email, as long as the keys requirements I, II and III are satisfied. For example, instead of saving “BofA#551” in “Customer Ticket ID” field, Dell CRM could keep [BofA#551] as part of the ticket subject and in the subject of any response email back to BofA helpdesk; Instead of support@dell.com in the “To” field of the header, the initial escalation email from BofA helpdesk to Dell could be addressed to something like “bofa.helpdesk.escalation.to.dell@dell.com” so that Dell CRM can use the “To” field in the header of the inbound email to identify the customer, and the “From” field becomes less relevant.

It is also to be noted what has been described can be used for data synchronization between two systems or organizations, and does not have to be escalation, although “vendor escalation” is used in the FIG. 1.

How to scale the integration to more than two systems and allow multiple levels of vendor escalation?

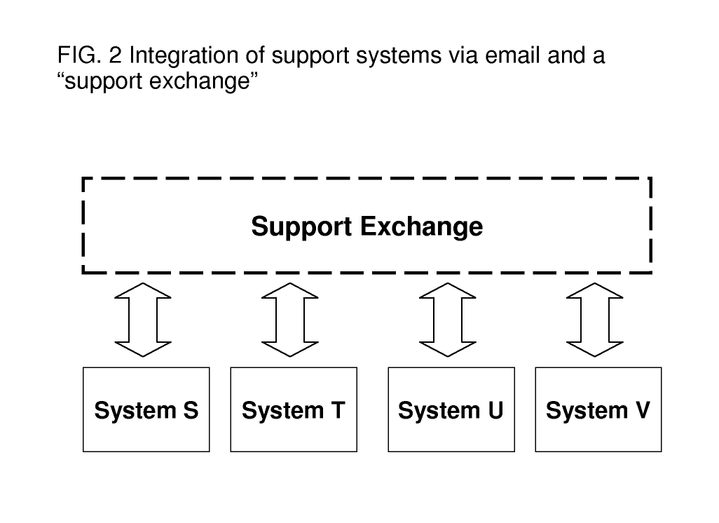

A real world support system may require integration with multiple external support systems, and escalation could reach multiple levels of vendors. The earlier discussion about integrating two systems may not scale well in those scenarios, because the key requirements I, II and III in integrating two systems also mean the systems need to know how to communicate with each other. For instance, BofA may have HP, IBM, Samsung as vendors in additional to Dell. Therefore, BofA helpdesk would also need to escalate to HP, IBM, Samsung CRM systems respectively, and each one of the vendors and systems will likely handle an escalation email from BofA differently. One way to implement a solution allowing BofA helpdesk escalations to Dell, HP, IBM, and Samsung is to configure four “point-to-point” email integrations: BofA and Dell; BofA and HP; BofA and IBM; and BofA and Samsung. Furthermore, there are potentially integration needs among Dell, HP, IBM and Samsung. A better solution would be a single integration for each system to a hub, or Exchange, and leave the complexity to the Exchange as describe in FIG. 2

FIG. 2 depicts integration of support systems via email and a “support exchange”.

A support hub, or Exchange is a hosted multi-organization, multi-tenancy ticket management system that is also capable of facilitating integration of ticketing systems and escalations among organizations. The Exchange also provides capability for organizations to configure a list of “customer” organizations and systems it takes inbound escalations from, and a list of “vendor” organizations and systems that it escalates outbound to. Such configurations allow an organization to establish support “partner” relationships, as well as both inbound and outbound email formats with respect to individual partner systems.

As depicted in FIG. 2, existing support systems such as S, T, U and V, potentially owned and operated by different organizations, can connect to, via email or other means to the Support Exchange. Organizations can also use the support exchange as a hosted ticketing system. The exchange can be used to transmit ticket information to other systems that also have access to the exchange, as well as to organizations using the hosted solution.

With the support exchange, the integration of systems such as S and T is through S and Exchange, then Exchange and T. The integration between S and Exchange as well as Exchange and T is similar to the direct integration of two systems described earlier except that the Exchange may not be the final message destination or source. When the Exchange receives an email from S, the intended destination could be System T, or U, or V etc. Therefore, emails carrying ticket information between support systems and the Exchange need to identify the destination. For example, if Kevin Smith at Bank of America IT helpdesk needs to escalate a ticket to Dell using the exchange, he could indicate the destination by emailing BofA.To.Dell@exchangecase.com so that the exchange knows how to compose another message to support@dell.com. Note that the address BofA.To.Dell@exchangecase.com would be a pre-configured address in the Exchange system.

The Support Exchange has the following advantages:
Each system has a single integration point—the Exchange. As a comparison, a the point-to-point integration of four systems requires 4×3=12 integration links if all need to talk to each other, and the integration links is reduced to 4 if each of the four systems are connected to the exchange. The complexity is dramatically reduced.
The Exchange can reduce or eliminate customization needed by each system in order to integrate. The Exchange is capable of handling different email formats used currently by many support systems, so that it can adapt and accommodate different systems and platforms so that each individual system customization can be reduced to minimum or none at all. In other words, the complexity is absorbed the exchange itself. And, because email is a built-in capability of many support systems, integration may be achieved without an adapter that is traditionally installed with each system for integration.
The Exchange provides standard or template email formats for inbound and outbound messages so that individual systems could follow.

A Support Exchange should not be confused with an email server such as Microsoft Exchange that is responsible for email delivery, although a Support Exchange may rely on email servers to deliver messages between the Exchange and other support systems. A Support Exchange provides multi-tenancy support ticket management that is also capable of taking an email and translated into a ticket, and vice versa, but it's not about email delivery or email management.

It is understood and appreciated that this invention addresses the format of email as the messaging format between two ticketing systems. This invention does not limit how emails are delivered, what protocol or email servers are used, nor does it limit a particular specification of the email format to be used as long as the principle used by this invention is preserved. There are provisions, standards and extensions for the transmission of images, audio, or other sorts of structured data in electronic mail messages, such as the MIME document series [RFC2045, RFC2046, RFC2049], many of them can be used to carry data of similar type in support cases.

Although the invention has been described with reference to the embodiment illustrated in the attached drawing figures, there are not intended to be exhaustive or to limit the invention to the precise form disclosed, and obviously many modifications and variations are possible in light of the above teachings. Such modifications are apparent to a person skilled in the art and are intended to be included within the scope this invention.

What is claimed is:

1. A method for integrating a plurality of support case management systems using email as messaging vehicle among said systems, comprising
a) providing identification of a source system and a target system of a message in an email,
b) associating internal case identification by at least one of said source and target systems with case identification of the other system based on said email, and
c) mapping fields of said email from said source system into case fields of said target system based on predetermined rules.

2. The method of claim 1, wherein said email is in compliance with RFC 2822, its amendments and revisions.

3. The method of claim 1, wherein further includes identifying said source system by the “From” address of said email.

4. The method of claim 1, wherein further includes identifying said target system by the “To” address of said email.

5. The method of claim 1, wherein further includes allowing said target system to be the source of the next target in a chain of systems.

6. The method of claim 1, wherein further includes allowing a single email message addressed to a plurality of target systems.

7. The method of claim 1, wherein further includes providing a Support Exchange, comprising:
a) registering and maintaining a plurality of support case management systems as members,
b) relaying messages among members, and
c) providing email as a messaging vehicle between member systems and said Support Exchange.

8. The method of claim 7, wherein further includes providing configuration of relationships among member systems.

9. The method of claim 7, wherein further includes providing compatibility with existing email formats of member systems.

10. The method of claim 7, wherein further includes providing a plurality of messaging vehicles including one or more of web services, http, https, ftp, REST, SOAP, XML, EDI, database, file, RSS between member systems and said Support Exchange.

11. The method of claim 7, wherein further includes allowing one side of source and target member systems pertaining to a given message to use email as a messaging vehicle and the other to use a different messaging vehicle.

12. A distributed Support Exchange system, comprising
a) a plurality of support case management systems as members,
b) a means for relaying messages from source members to target members, and
c) a means for providing email as a messaging vehicle between member systems and said Support Exchange.

13. The distributed Support Exchange system of claim 12, wherein further includes a means for providing configuration of relationships among member nodes.

14. The distributed Support Exchange system of claim 12, wherein further includes a means for providing compatibility with existing email formats of member nodes.

15. The distributed Support Exchange system of claim 12, wherein further includes a means for providing a plurality of messaging vehicles including one or more of web services, http, https, ftp, REST, SOAP, XML, EDI, database, file, RSS between member systems and said Support Exchange.

16. The distributed Support Exchange system of claim 12, wherein further includes a means allowing one side of source and target member systems pertaining to a message to use email as a messaging vehicle and the other to use a different messaging vehicle.
